(19) United States
(12) Patent Application Publication
(10) Pub. No.: US 2022/0362909 A1
(43) Pub. Date: Nov. 17, 2022

(54) RATCHET EXTENDER

(71) Applicant: Westin Olsen, Washington, UT (US)

(72) Inventor: Westin Olsen, Washington, UT (US)

(21) Appl. No.: 17/729,979

(22) Filed: Apr. 26, 2022

Related U.S. Application Data
(60) Provisional application No. 63/189,286, filed on May 17, 2021.

(51) Int. Cl. B25B 13/46; B25G 1/04

(52) U.S. Cl. CPC B25B 13/463; B25G 1/043; B25B 23/0035

(57) ABSTRACT

A ratchet extender includes a first head having at least one ratchet drive square receiver and a first drive gear, a second head having at least one ratchet drive square and a second drive gear, and a drive shaft coupling the first drive gear to the second drive gear. As a user rotates the first drive gear using a ratchet coupled to the ratchet drive square receiver, the drive shaft rotates, thereby rotating the second drive gear and the ratchet drive square coupled thereto. As a result, a user is able to use ratchets in locations previously unreachable by such tools.

### CROSS-REFERENCE TO RELATED APPLICATIONS

This application claims priority to U.S. Provisional Application Ser. No. 63/189,286, filed May 17, 2021, which is incorporated herein by reference.

### TECHNICAL FIELD

The present disclosure relates to ratchets. More particularly, the present disclosure relates to a ratchet extender that allows a user to access narrow spaces to tighten or loosen nuts and bolts.

### BACKGROUND

Wrenches have been around for years to apply torque and loosen or tighten any size of nut or bolt. In fact, it has been noted that wrenches can be found as far back as the 15^{th} century. Wrenches are an invaluable tool that allow many professions to succeed, especially with many types of wrenches available for numerous tasks. Some of the common wrenches on the market include open-end wrenches, box-end wrenches, combination wrench, flare-nut wrench, and socket and flex-head socket wrenches.

Wrenches are relied on in many professions, particularly in a mechanic's profession. Even though wrenches are essential to a mechanic's job, at times, the wrenches may not function as needed because they cannot fit into or reach a hidden nut or bolt. When nuts and bolts are impossible to reach with standard wrenches, a user may have to spend additional time removing parts of a vehicle to access them, which becomes frustrating and wastes valuable time. To address this issue, some on the market have created longer wrenches and ratchet extensions. However, with these improvements, there are still many shortcomings. For example, a ratchet extension on the market includes a housing with two sprocket gears at each end and a chain connecting the two. A ratchet goes on one end and a socket on the other. This ratchet extension has numerous problems, such as being too thick to reach into tight areas, and because it is chain driven, it is wide and non-extendable. Accordingly, a user would be limited not only in accessing nuts and bolts in narrow spaces but would also be limited in accessing them at certain distances. Further, due to the chain, the strength of the ratchet extension is limited, and multiple failure points are created.

Accordingly, there is a need for an extension for a wrench and/or ratchet that is thin, extendable, limits failure points, and withstands high levels of torque. The present disclosure seeks to solve these and other problems.

### SUMMARY OF EXAMPLE EMBODIMENTS

In some embodiments, a ratchet extender comprises a telescopic length, which may be accomplished using a first housing tube with a first cylindrical housing coupled thereto, a second housing tube, smaller than the first housing tube, may be inserted into and coupled to the first housing tube, allowing the second tube to be extended or retracted in a telescopic fashion. A telescopic drive shaft is received within the first and second housing and drives a plurality of gears.

In some embodiments, a ratchet extender comprises a housing tube with a first cylindrical housing coupled to a first end of the housing tube and a second cylindrical housing coupled to a second end of the housing tube. The first cylindrical housing comprises a first rachet drive square receiver on a first side and second rachet drive square receiver on a second side. The second cylindrical housing comprises a hex head receiver on a first side and a rachet drive square on a second side. A drive shaft drives a gear in each cylindrical housing, thereby rotating

### BRIEF DESCRIPTION OF THE DRAWINGS

FIG. 1 illustrates a top perspective view of a ratchet extender with a first shaft tube, a second shaft tube, and a shaft removed therefrom;

FIG. 2 illustrates a bottom, side perspective view of a ratchet extender with a first shaft tube, a second shaft tube, and a shaft removed therefrom;

FIG. 3 illustrates a detailed, top perspective view of a first cylindrical housing and a ratchet drive of a ratchet extender;

FIG. 4 illustrates a side elevation view of a ratchet extender;

FIG. 5 illustrates a side, top perspective view of a ratchet extender;

FIG. 6 illustrates a side, bottom perspective view of a ratchet extender;

FIG. 7 illustrates a bottom plan view of a ratchet extender;

FIG. 8 illustrates a top plan view of a ratchet extender;

FIG. 9 illustrates a side elevation view of a ratchet extender;

FIG. 10 illustrates a longitudinal cross-section of a ratchet extender;

FIG. 11 illustrates internal components of a ratchet extender, including a drive shaft and drive gears; and

FIG. 12 illustrates a detailed, side elevation view of a ratchet extender partially exploded.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As discussed earlier, there is a need for an extension for a wrench and/or ratchet that is thin, extendable, limits failure points, and withstands high levels of torque. The present disclosure seeks to solve these and other problems.

Ratchet extensions in the prior art have many shortcomings. For example, the ratchet extensions on the market are too thick to reach into tight areas and are chain driven, which prevents the ratchet extensions from being extendable and thin enough to be maneuverable. These shortcomings severely limit the uses of ratchet extensions in the prior art. Accordingly, the ratchet extender described herein solves the issues found in the prior art. In particular, the ratchet extender comprises a slim housing tube that is capable of fitting into small spaces where access is limited. In addition, the ratchet extender functions by using a shaft within the housing tube. On each end of the shaft is a bevel gear that interacts with housing gears when a ratchet drive is rotated. The ratchet drive may receive a ratchet, and when rotated, take rotational movement and convert it to torsional movement through the center shaft to the opposing housing bevel gear, which allows a nut or bolt to be tightened or loosened. It will be appreciated that the ratchet extender may, in some embodiments, be extendable so as increase length.

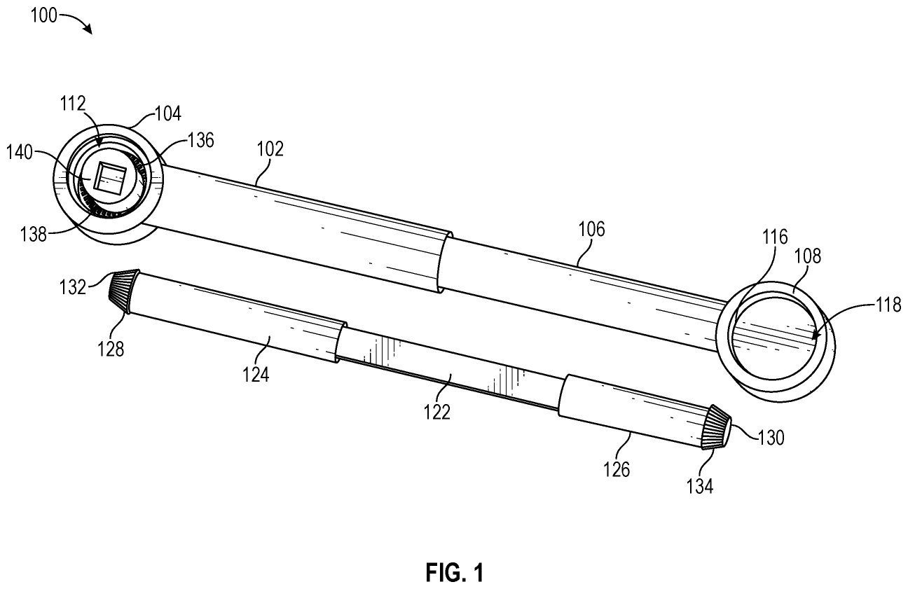

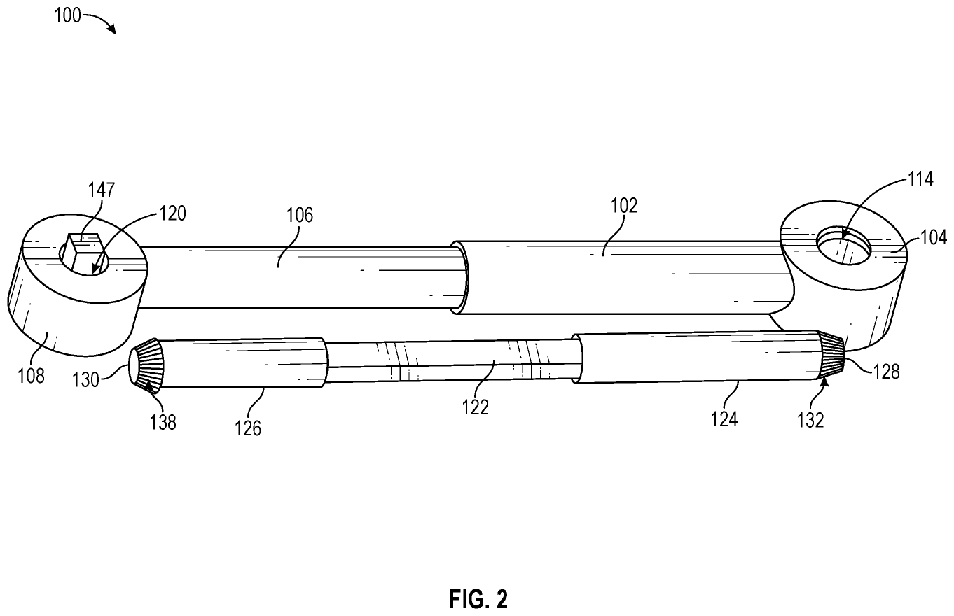

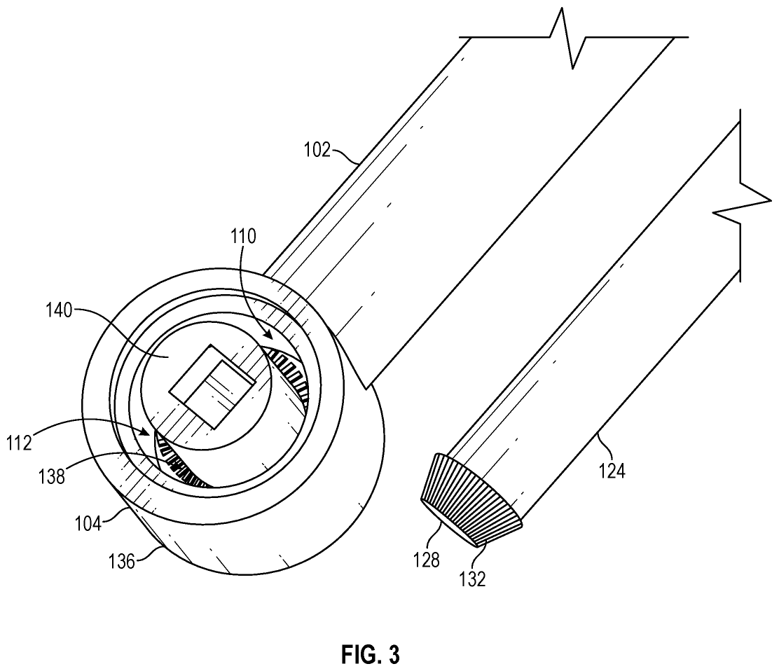

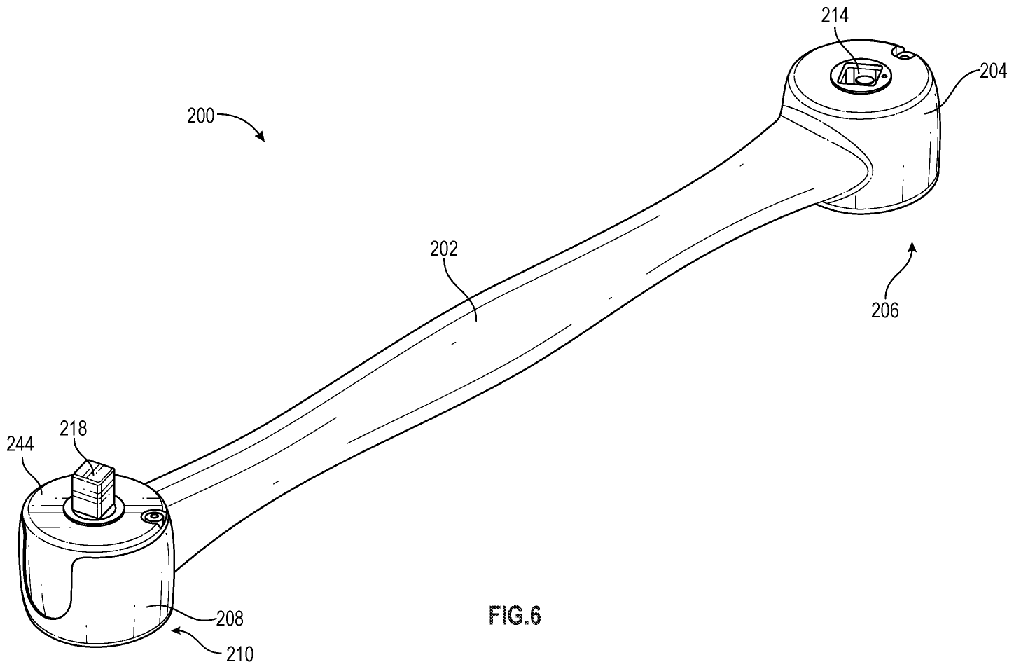

Referring now to FIGS. 1-6, in one embodiment, a ratchet extender 100 comprises a first housing tube 102 with a first cylindrical housing 104. A second housing tube 106, having an outer diameter smaller than the inner diameter of the first housing tube 102, may be inserted into and coupled to the first housing tube 102 in a manner that allows the second housing tube 106 to be extended or retracted (i.e., telescopic). It will be appreciated that the ratchet extender 100 may comprise a variety of widths as well as retracted lengths and extendable lengths. It will further be appreciated that the first and second housing tubes 102, 106 are not limited to being tubular in shape and may be any other shape. Also, the second housing tube 106 comprises a second cylindrical housing 108. The first cylindrical housing 104 and the second cylindrical housing 108 may be perpendicular to the first and second housing tubes 102, 106.

The first cylindrical housing 104 comprises a first shaft aperture 110, a first housing aperture 112, and a second housing aperture 114. The second cylindrical housing 108 comprises a second shaft aperture 116, a third housing aperture 118, and a fourth housing aperture 120. A shaft 122 may be interposed between a first shaft tube 124 and a second shaft tube 126. The shaft 122 may be retracted into the first and/or second shaft tubes 124, 126 so as to decrease the length of the ratchet extender 100. Additionally, the distance between the first shaft tube 124 and the second shaft tube 126 may increase, thereby increasing the length of the ratchet extender 100.

As illustrated, the shaft may be hexagonal in shape so as to allow rotation of the first and second shaft tubes 124, 126 simultaneously, as well as the ability of the first and second shaft tubes 124, 126 to slide along the shaft 122 so as to be extendable. In some embodiments, the shaft 122 is a splined shaft with grooves cut into the shaft. A splined shaft, similar to the hexagonal shaft, allows the shaft 122 to slide within the first and second shaft tubes 124, 126 as well as grip grooves or channels within the tubes 124, 126 so as to allow rotation. The first and second shaft tubes 124, 126 and the shaft 122 are positioned inside of the first and second housing tubes 102, 106 and extend out of the first shaft aperture 110 and the second shaft aperture 116. Accordingly, the shaft 122 and first and second shaft tubes 124, 126 work in conjunction with the first and second housing tubes 102, 106.

The first shaft tube 124 comprises a first bevel gear 128 coupled thereto and the second shaft tube 126 comprises a second bevel gear 130 coupled thereto, both of which extend into the first cylindrical housing 104 and the second cylindrical housing 108, respectively. The first bevel gear 128 may comprise a plurality of first teeth 132 and the second bevel gear 130 may comprise a plurality of second teeth 134. In addition, the first cylindrical housing 104 may comprise a first cylindrical housing gear 136 with a plurality of first housing gear teeth 138 and a ratchet drive 140 coupled to the first cylindrical housing gear 136. The plurality of first housing gear teeth 138 may be configured to interact with the plurality of first teeth 132 on the first bevel gear 128.

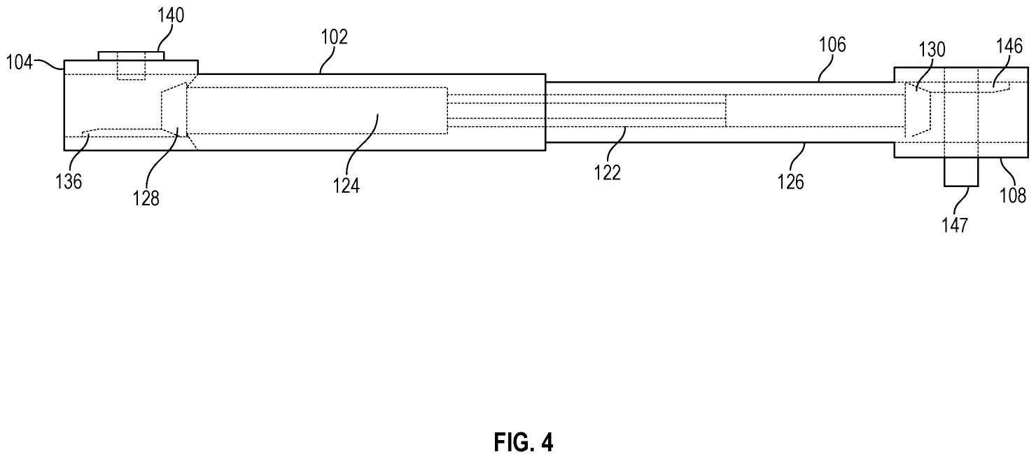

Likewise, as best seen in FIG. 4, the second cylindrical housing 108 may comprise a second cylindrical housing gear 146 (which comprises a plurality of second housing gear teeth) and an adapter drive 147. The plurality of second housing gear teeth may be configured to interact with the plurality of second teeth 134 on the second bevel gear 130. In some embodiments, the first cylindrical housing gear 136 may sit on top of the first bevel gear 128 while the second cylindrical housing gear 142 may sit below the second bevel gear 130. It will be appreciated the first and second tube housings 102, 106 may be stationary while the first cylindrical housing gear 136 and the second cylindrical housing gear 142 rotate in the same direction at the applied speed and power applied to the opposite gear. A user may couple a ratchet to the ratchet drive 140. Once the user turns the ratchet drive 140, the rotational movement is translated into torsional movement through the shaft 122 and the adapter drive 147 rotates, thereby tightening or loosening a nut or bolt. It will be appreciated that any size of socket may be coupled to the adapter drive 147.

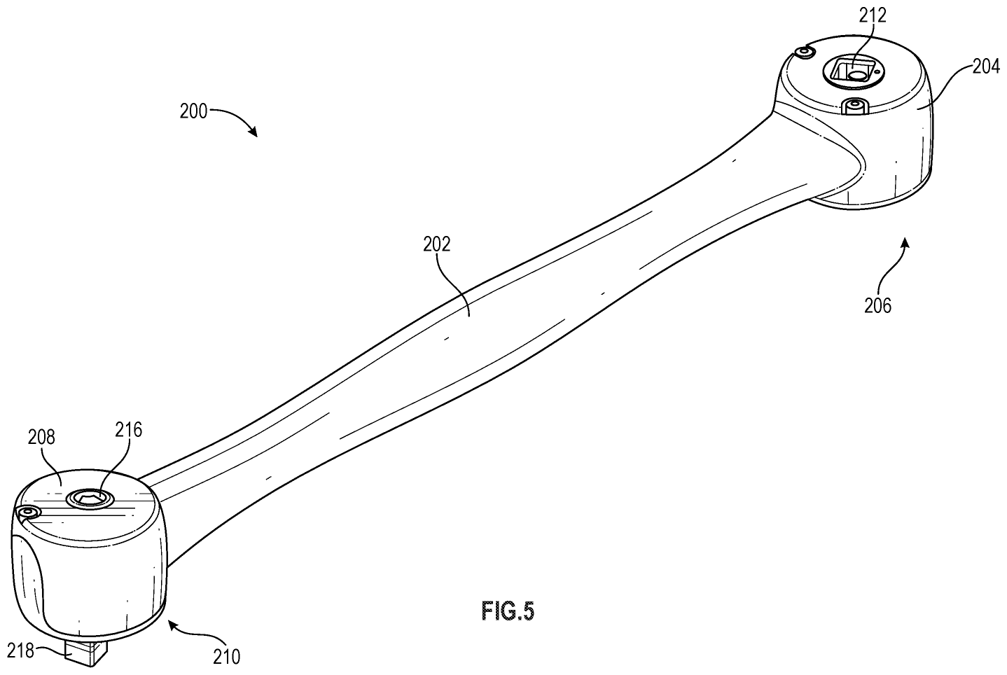

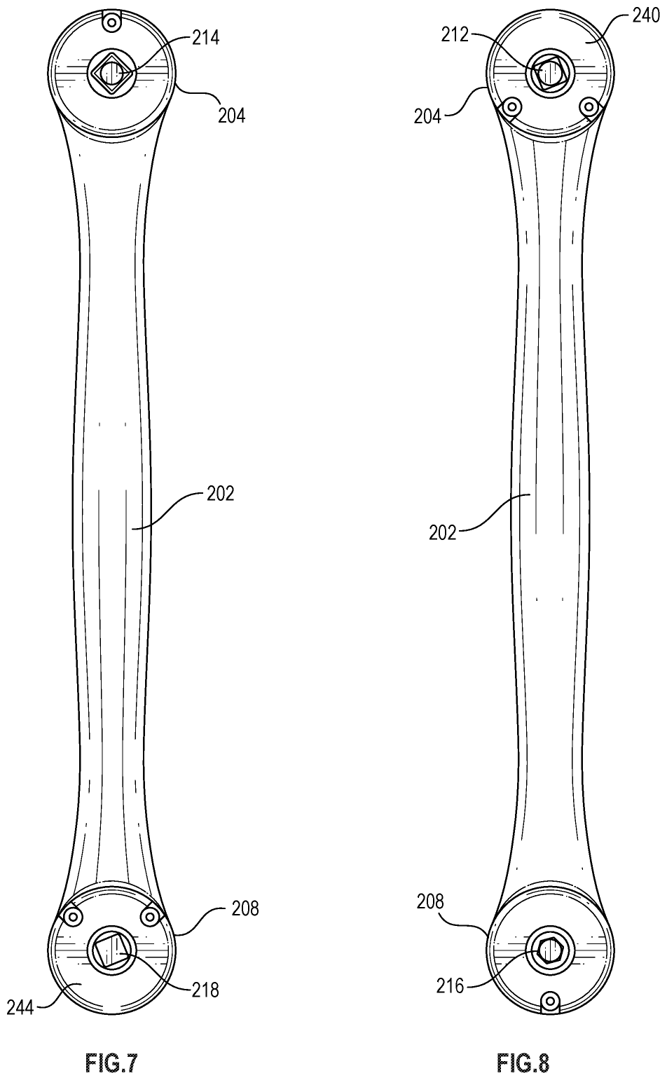

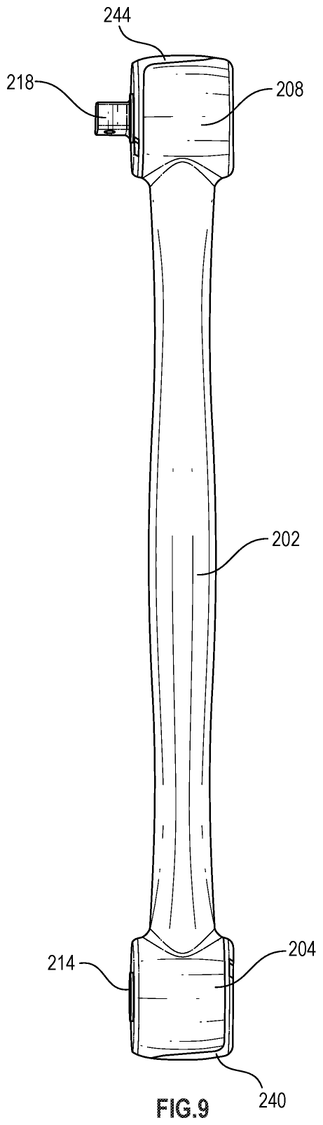

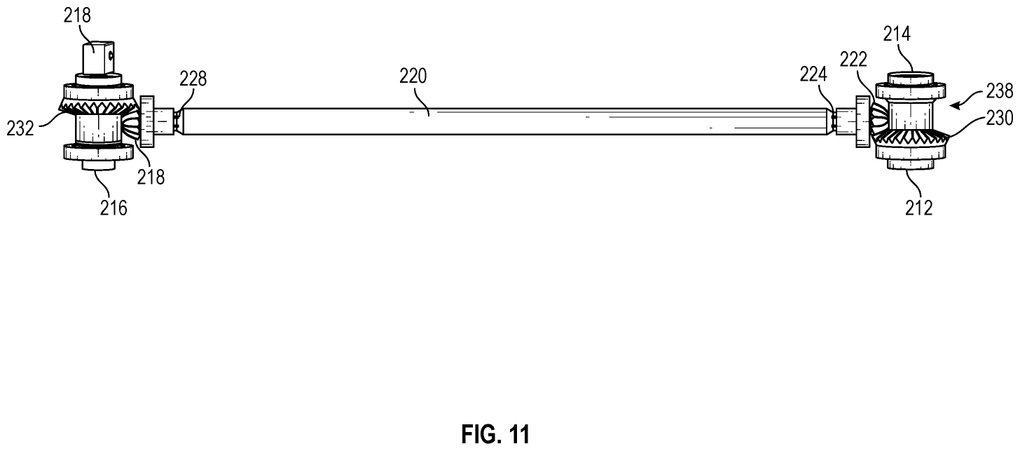

As shown in FIGS. 5-12, in some embodiments, a ratchet extender 200 comprises a housing tube 202 with a first cylindrical housing 204 coupled (e.g., welding) to a first end 206 of the housing tube 204 and a second cylindrical housing 208 coupled (e.g., welding) to a second end 210 of the housing tube 204. The first cylindrical housing 204 and the second cylindrical housing 208 may be longitudinally perpendicular to the housing tube 204. The first cylindrical housing 204 comprises a first ratchet drive square receiver 212 on a first side and second ratchet drive square receiver 214 on a second side. The second cylindrical housing 208 comprises a hex head receiver 216 on a first side and a ratchet drive square 218 on a second side.

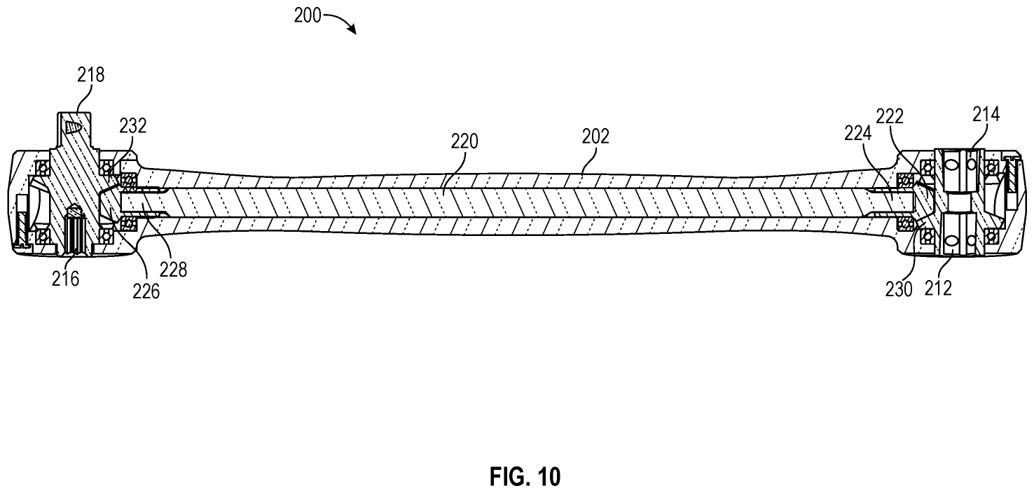

Referring to FIGS. 10-12, the housing tube 202 receives a drive shaft 220. A first pinion gear 222 is coupled to a first end 224 of the drive shaft 220. A second pinion gear 226 is coupled to a second end 228 of the drive shaft 220. The first pinion gear 222 meshes with a first drive gear 230 and the second pinion gear 226 meshes with a second drive gear 232. The first drive gear 230 is coupled to the first ratchet drive square receiver 212 and the second drive square receiver 214. The second drive gear 232 is coupled to the ratchet drive square 218 and the hex head receiver 216.

As appreciated, a user may insert a ratchet drive square of a ratchet (not shown) into one of either of the first or second ratchet drive square receivers 212, 214, respectively. As a user actuates the ratchet, first and second ratchet drive square receivers 212, 214 rotate, which likewise rotates the first drive gear 230. The first drive gear 230 causes the first pinion gear 222 to rotate, which thereby rotates the drive shaft 220. Rotation of the drive shaft 220 likewise rotates the second pinion gear 226, which is meshed with second drive gear 232, causing the second drive gear 232 to rotate. The second drive gear 232 thereby causes both the ratchet drive square 218 and hex head receiver 216 to rotate. It will be appreciated that ball bearings may be used to ensure rotation of any gears disclosed herein (e.g., ball bearings may be positioned between moving parts (e.g., gears) and stationary parts).

For example, in one method of use, a user would couple a ratchet to either the first or second ratchet drive square receiver 212, 214, respectively. On the second end 210, a user may couple a socket to the ratchet drive square 218. As the user actuates the ratchet on the first end 206, the socket coupled to the second end 210 rotates accordingly. Likewise, a user may couple a tool having a hex head to the hex head receiver 216, wherein when a user rotates a ratchet on the first end 206, the hex head receiver 216 likewise rotates. While shown and described as a hex head, it will be appreciated that other configurations/shapes may be used that are adapted to fit other tools. This allows a user to use multiple tools, sockets, as well as utilize either side with a ratchet by having two ratchet drive square receivers 212, 214, overcoming limitations in the prior art.

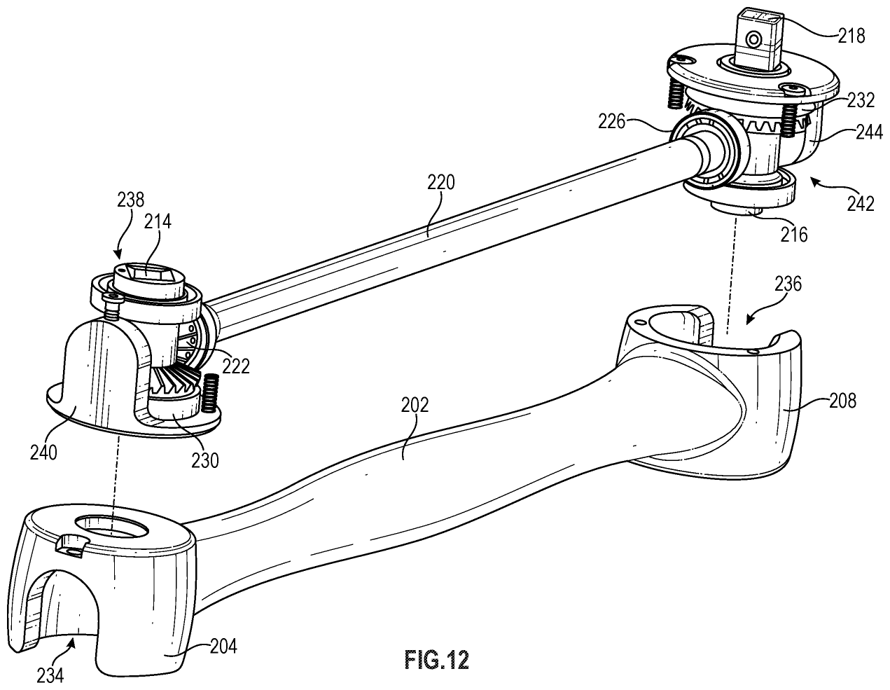

Referring to FIG. 12, a method of assembly may comprise inserting the drive shaft 220 into the tube 202 via a first cylinder opening 234 of a first cylinder 204. Once received, a user may couple the first pinion gear 222 to the drive shaft 202, such as by pressing a female receiver onto a male portion, which is non-cylindrical to ensure rotation (e.g., square, hex, etc.). The second pinion gear 226 may then be coupled to the opposite end 228 via a second cylinder opening 236 of the second cylinder 208 in the same manner as the first. A user may then insert a first head 238 (comprising the first and second ratchet drive square receivers 212, 214 and first drive gear 230) into the first cylinder 204 via the first opening 234 so that the first pinion gear 222 meshes with the first drive gear 230. Once seated, a first cap 240 may be secured so as to cover the first opening 234 of the first cylinder 204 to prevent withdrawal of the first head 238. Likewise, a second head 242 (comprising the ratchet drive square 218, hex head receiver 216, and second drive gear 232) may be inserted into the second cylinder 208 via a second cylinder opening 236 so that the second pinion gear 226 meshes with the second drive gear 232. Once seated, a second cap 244 may be coupled (e.g., threading screws) to cover the second opening 236 of the second cylinder 208 to prevent withdrawal of the second head 242.

It will be appreciated that the ratchet extender 100, 200 allows a user to reach into locations where space is limited. By utilizing a drive shaft 122, 220, the housing tube 102, 202 remains narrow, allowing a user to insert it into spaces not reachable by tools in the prior art. Additionally, the ratchet extender 100, 200 allows a user to couple a ratchet to either side and allows for hex head tools in addition to sockets. The ratchet extender 100 is extendable (telescopic) so as to reach nuts, bolts, or other objects that can not be reached by the extenders shown in the prior art. Specifically, the prior art teaches ratchet extenders that utilize internal chains, thereby preventing any sort of extension of the body and that require wider housings as a result of the looped chain.

It will also be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A ratchet extender, comprising:
a housing tube;
a first cylindrical housing coupled to a first end of the housing tube, the first cylindrical drive housing comprising:
a first ratchet drive square receiver on a first side, and
a second ratchet drive square receiver on a second side;
a second cylindrical housing coupled to a second end of the housing tube, the second cylindrical housing comprising a ratchet drive square;
a drive shaft received through the housing tube and coupling the first and second ratchet drive square receivers of the first cylindrical housing to the ratchet drive square of the second cylindrical housing.

2. The ratchet extender of claim 1, wherein the second cylindrical housing further comprises a hex head receiver.

3. The ratchet extender of claim 1, further comprising a first pinion gear coupled to a first end of the drive shaft and a second pinion gear coupled to a second end of the drive shaft.

4. The ratchet extender of claim 1, further comprising a first drive gear interposed between the first and second ratchet drive receivers of the first cylindrical housing.

5. The ratchet extender of claim 1, further comprising a second drive gear coupled to the ratchet drive square of the second cylindrical housing.

6. The ratchet extender of claim 1, wherein the drive shaft is telescopic.

7. The ratchet extender of claim 6, wherein the housing tube is telescopic.

8. A ratchet extender, comprising:
a housing tube;
a drive shaft extending through the housing tube;
a first pinion gear coupled to a first end of the drive shaft;
a second pinion gear coupled to a second end of the drive shaft;
a first drive gear configured to mesh with the first pinion gear, the first drive gear further comprising a first ratchet drive square receiver and a second ratchet drive square drive receiver;
a second drive gear configured to mesh with the second pinion gear, the second drive gear comprising a ratchet drive square;
a first cylindrical housing coupled to a first end of the housing tube and configured to house the first pinion gear and the first drive gear, the first cylindrical housing comprising a first cap;
a second cylindrical housing coupled to a second end of the housing tube, the second cylindrical housing configured to house the second pinion gear and the second drive gear, the second cylindrical housing comprising a second cap.

9. The ratchet extender of claim 8, wherein the second drive gear further comprises a hex head receiver.

10. The ratchet extender of claim 8, wherein the drive shaft is telescopic.

11. The ratchet extender of claim 11, wherein the housing tube is telescopic.
